(19) United States
(12) Patent Application Publication
(10) Pub. No.: US 2015/0089370 A1
(43) Pub. Date: Mar. 26, 2015

(54) METHOD AND DEVICE FOR PLAYING MEDIA DATA ON A TERMINAL

(71) Applicant: Tencent Technology (Shenzhen) Co., Ltd., Shenzhen (CN)

(72) Inventor: Hui Tang, Shenzhen (CN)

(21) Appl. No.: 14/487,754

(22) Filed: Sep. 16, 2014

Related U.S. Application Data
(63) Continuation of application No. PCT/CN2014/080082, filed on Jun. 17, 2014.

(30) Foreign Application Priority Data
Sep. 25, 2013 (CN) 2013104433604

(51) Int. Cl. G06F 3/0484

(52) U.S. Cl. CPC G06F 3/04847
USPC 715/716

(57) ABSTRACT

A method, device and terminal for playing media data on a terminal have been disclosed. The method including: acquiring a first instruction which operates on a first identification displayed on an interactive interface of a social application; acquiring a media link corresponding to the first identification displayed on the interactive interface according to the first instruction; acquiring corresponding media data according to the media link; and directly playing the acquired media data on the interactive interface of the social application without being redirected to play the acquired media data through a third party webpage or a web application.

### CROSS-REFERENCE TO RELATED APPLICATIONS

The application is a continuation of PCT Application No. PCT/CN2014/080082, filed on Jun. 17, 2014, which claims priority to Chinese Patent Application No. 2013104433604, filed on Sep. 25, 2013, which are incorporated by reference in their entireties.

### FIELD OF THE TECHNOLOGY

The invention belongs to the field of Information Processing technology; to a method, device and terminal for playing media data.

### BACKGROUND

With the rapid development of information technology, more and more people are inclined to share steams of media data such as their favorite music, videos with their circle of friends. Usually, these shared media data may appear in a shared domain in the form of media links. Some studies have been done on how to play streams of media data much quicker with more convenience.

Existing technology typically handles such problem by acquiring a command of media data streams corresponding to a media link on an interactive interface of a social application, afterwards, the interactive interface of the social application may then skip to a third party webpage (i.e., a website location which hosts or redirect to the media, such as You Tube) or skip to a third party web application (such as Webview). Therefore, the media link on the interactive interface of the social application may also correspond to the media data of a third party application. Accordingly, the media data of the third party application may be played on an interactive interface of the third party web application.

For example, a user may like to share a favorite video or a favorite music with a friend on a social website by posting the favorite video link or music link on the social website. A user's friend may click on the video link to watch the video or click on the music link to listen to the music. Upon clicking the video link or the music link, the social website may be redirected to a third party web application (such as Webview) and then further be redirected to a host server which hosts the content of the media (e.g., You Tube) in order to start streaming the video or music content to the user's friend's web browser.

As seen, the existing technology has the following disadvantageous:

The process of playing the media data though skipping to a third party application increases resource consumption of the system adds to the user's wait time, thereby resulting in low playing efficiency of the media data. In addition, the skipping process increases the complexity of playing the media data, bringing inconvenience to the users.

### SUMMARY

An embodiment of the present disclosure has provided a method for playing media data on a terminal, the method including: acquiring a first instruction which operates on a first identification displayed on an interactive interface of a social application; acquiring a media link corresponding to the first identification displayed on the interactive interface according to the first instruction; acquiring corresponding media data according to the media link; and directly playing the acquired media data on the interactive interface of the social application without being redirected to play the acquired media data through a third party webpage or a web application.

Another embodiment of the disclosure discloses a device for playing media data, which includes at least a processor operating in conjunction with at least a memory which stores instruction codes operable as plurality of modules, wherein the plurality of modules may include: a first acquisition module, which acquires a first instruction which operates on a first identification displayed on an interactive interface of a social application; a second acquisition module, which acquires a media link corresponding to the first identification displayed on the interactive interface according to the first instruction; a third acquisition module, which acquires corresponding media data according to the media link; and a play module, which directly plays the acquired media data on the interactive interface of the social application without being redirected to play the acquired media data through a third party webpage or a web application.

Another embodiment of the disclosure discloses a terminal for playing media data, which includes at least a processor operating in conjunction with at least a memory and a non-transitory computer readable medium which stores instruction codes operable to carry out steps, including: acquiring a first instruction which operates on a first identification displayed on an interactive interface of a social application; acquiring a media link corresponding to the first identification displayed on the interactive interface according to the first instruction; acquiring corresponding media data according to the media link; and directly playing the acquired media data on the interactive interface of the social application without being redirected to play the acquired media data through a third party webpage or a web application.

The beneficial effects of the technical scheme provided by the embodiment of the present disclosure include: directly playing the acquired media data on the interactive interface of the social application without being redirected to play the acquired media data through a third party webpage or a web application, thus reduces resource consumption of the system. In addition, the user wait time has been shortened, thus increasing the playing efficiency of the media data. Moreover, since the media data is being played without skipping to another interface of a third party application, so the complexity of playing the media data may also be reduced.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1 is an exemplary flowchart illustrating a method of playing media data in a terminal, according to a first embodiment of the disclosure.

FIG. 2 is an exemplary flowchart illustrating a method of playing media data in a terminal, according to a second embodiment of the disclosure.

FIG. 3 is an exemplary schematic diagram of an interactive interface for a social application, according to an embodiment of the disclosure.

FIGS. 4(1) to 4(2) are exemplary schematic diagrams of an interactive interface for a social application, according to another embodiment of the disclosure.

FIG. 5 is an exemplary flowchart illustrating a method of playing media data in a terminal, according to a third embodiment of the disclosure.

FIG. 6 is an exemplary flowchart illustrating a method of playing media data in a terminal, according to a fourth embodiment of the disclosure.

FIG. 7 is an exemplary flowchart illustrating a method of playing media data in a terminal, according to a fifth embodiment of the disclosure.

FIG. 8 is an exemplary structural diagram of a playing device of a first media data, according to a sixth embodiment of the disclosure.

FIG. 9 is an exemplary structural diagram of a playing device of a second media data, according to a sixth embodiment of the disclosure.

FIG. 10 is an exemplary structural diagram of a playing device of a third media data, according to a sixth embodiment of the disclosure.

FIG. 11 is an exemplary structural diagram of a playing device of a fourth media data, according to a sixth embodiment of the disclosure.

FIG. 12 is an exemplary structural diagram of a playing device of a fifth media data, according to a sixth embodiment of the disclosure.

FIG. 13 is an exemplary structural diagram of a playing terminal of media data, according to a seventh embodiment of the disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features may be referenced back to the prior descriptions in a prior numbered drawing or referenced ahead to a higher numbered drawing.

In order to clarify the object, technical scheme and advantages of the present disclosure more specifically, the present disclosure is illustrated in further details with the accompanied drawings and embodiments. It should be understood that the embodiments described herein are merely examples to illustrate the present disclosure, not to limit the present disclosure.

Information is exchanged between humans and terminals (desk top computers, laptops, mobile terminals, computing tablets, computing pads and smart phones etc.) through an interactive interface, where information input and operation towards the terminals may be realized by users via the interactive interface. The interactive interface in an application may include a homepage when starting software or an application. An interactive interface may also be started after clicking on a respective function button or tool bar entry.

An interactive interface may appear in difference levels or result from different triggering operations belonging to different interactive interfaces. An interactive interface from a same triggering or entry may belong to a same interactive interface irrespective of read contents therein. In general, different interactive interfaces may be related only at a display level for the users, but not related at the contents level.

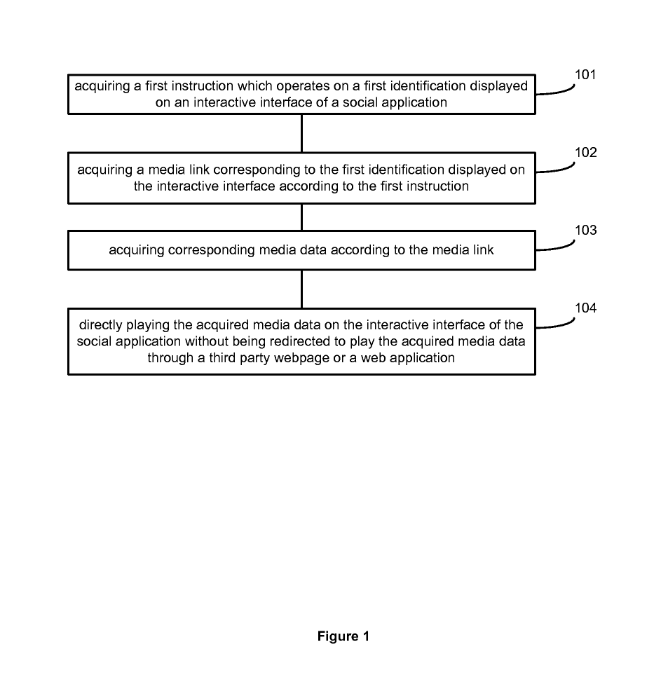

The solution to solving a problem of displaying a media link corresponding to media data of other applications on an interactive interface of a social application may be illustrated in the following embodiments disclosed. FIG. 1 is an exemplary flowchart illustrating a method of playing media data in a terminal, according to a first embodiment of the disclosure.

The process may include the at least the following steps:

Step 101: acquiring a first instruction which operates on a first identification displayed on an interactive interface of a social application.

Step 102: acquiring a media link corresponding to the first identification displayed on the interactive interface according to the first instruction.

Step 103: acquiring corresponding media data according to the media link.

Step 104: directly playing the acquired media data on the interactive interface of the social application without being redirected to play the acquired media data through a third party webpage or a web application.

Wherein, the directly playing of the acquired media data on the interactive interface of the social application without being redirected to play the acquired media data through a third party webpage or web application, including: directly playing the media data stored on a web server according to a Uniform Resource Locator (URL) address which corresponds to the media link, wherein the URL address has been embedded in the first identification displayed on the interactive interface of the social application.

The method disclosed enables the acquired media data be played on the interactive interface of the social application, so the media data may be played without skipping from the interactive interface of the social application to a third party webpage or another application, the resource consumption of the system and user's wait time are thus reduced, and the playing efficiency of the media data is increased. Moreover, since the media data are played in absence a third party web application, so the complexity of media data playing is reduced.

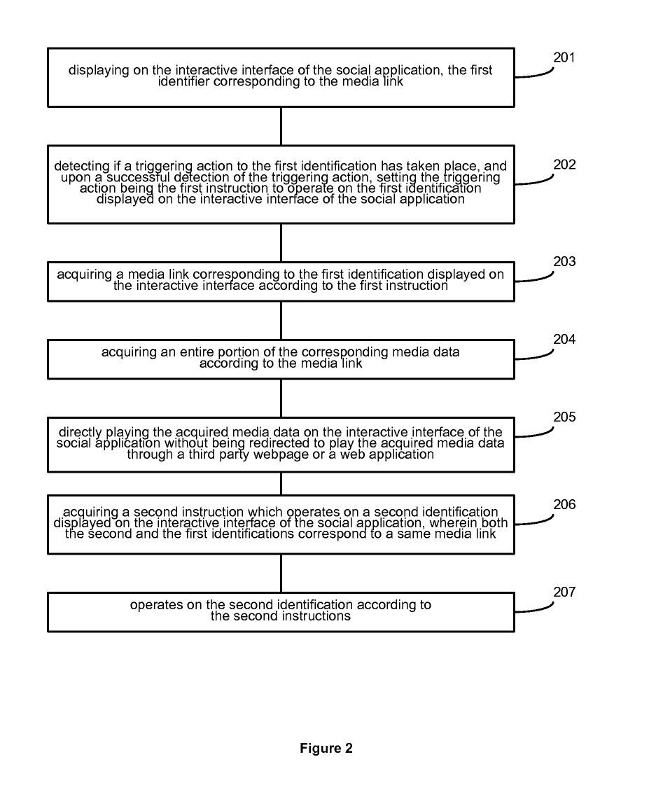

FIG. 2 is an exemplary flowchart illustrating a method of playing media data in a terminal, according to a second embodiment of the disclosure.

The process may include the at least the following steps:

Step 201: displaying on the interactive interface of the social application, the first identifier corresponding to the media link. In this step, the media link on the interactive interface of the social application may correspond to the media data of other applications including, but not limited to audio data and video data etc. The media data of these other applications are not subject to limitation of this embodiment.

The media link may correspond to the media data of other applications generated on the interactive interface of the social application after the media data of other applications are shared on the social application. For example, if the user logs in to other applications through the terminal and would like to share a stream of audio data from on an interactive interface of other applications, the interactive interface of the social application may display the media link corresponding to the stream of audio data. It is beyond the scope of the disclosure on how to share the streams of media data of the other applications with the social application. The interactive interface of other applications may display the shared media data items through a corresponding media link as a first identification, such that the user may make a selection on the first identification to play the selected shared media data directly on the social application interactive interface. In an embodiment, the first identification of a corresponding media link may be a play button icon of a song or a play button icon of a video clip, which is displayed on the social application interactive interface.

The media link on the interactive interface of the social application may be displayed through a name of the media data from other applications as well as through a Uniform Resource Locator (URL) address of the media link corresponding to the media data of the other applications. It is beyond the scope of the disclosure to describe how the corresponding media link on the social application is display. Moreover, the social application may be any social applications, such as WeChat®, Facebook®, Google Chat®, Yahoo® Instant Message, or Skype®, to name a few. In this regard, to directly play the media data, a user may simply click on an interactive interface of social application, a first identification (e.g., play button icon) which correspond to a media link.

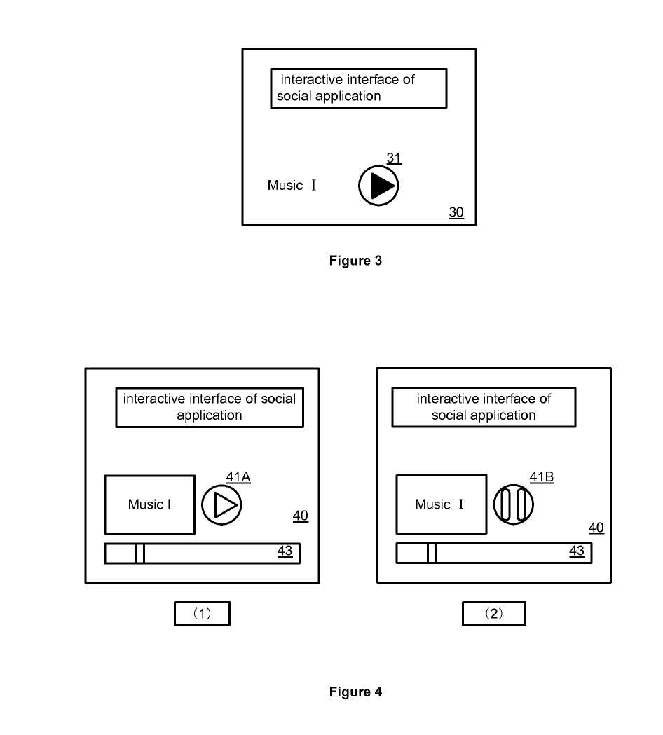

To facilitate understanding of the first identification, refer to FIG. 3, which is an exemplary schematic diagram of an interactive interface (30) for a social application, according to an embodiment of the disclosure. A media link on the interactive interface of social application (30) may be displayed as a name of the media data of other application, i.e., Music I (32). The play button (31) may be displayed behind the media link Music 1 (32).

It should be noted that when there are more than one media links on the interactive interface of social application (30), a respective first identification as well as a select box may be provided for each media link, respectively. The user may check a corresponding media link by clicking on a first identification (e.g., play button (31)) may be provided for playing the media data (i.e., Music 1 32)).

In Step 202: detecting if a triggering action (e.g., clicking) to the first identification (i.e., play button (31)) has taken place, and upon a successful detection of the triggering action, setting the triggering action (e.g., clicking) being the first instruction to operate on the first identification (i.e., play button (31)) displayed on the interactive interface of the social application (30).

Since the first identification (31) corresponding to the media link on interactive interface of social application is displayed on interactive interface of social application (30) in step 201, a subsequent playback operation may proceed by directly clicking the first identification (31). The detection of a triggering action by clicking on the first identification may include but not limited to: detecting a touch screen operation of user's terminal on the current interface (30), and then setting the detected touch screen operation as being the first identification as the acquired first instruction for operating on the first identification on the interactive interface of social application (30).

It should be noted that the acquisition of the first instruction for operating on the first identification on interactive interface of the social application may be completed through step 202. In order to play the media data, the method provided by this embodiment may include the following additional steps.

Step 203: acquiring a media link corresponding to the first identification displayed on the interactive interface according to the first instruction. Since the first instruction for operating on the first identification (31) on the interactive interface of social application (30) may be acquired in step 202, and the first identification (31) may be correlated to the media link. The media link corresponding to the first identification on the interactive interface (30) according to the first instruction may be acquired.

As for the acquisition of the media link corresponding to the first identification displayed on the interactive interface according to the first instruction, each media link corresponds to the respective first identification (i.e., respective play button (31)). When the first identification (31) is clicked, the first instruction which operates on the first identification may be acquired. In order to play the media data, the embodiment may include the following steps:

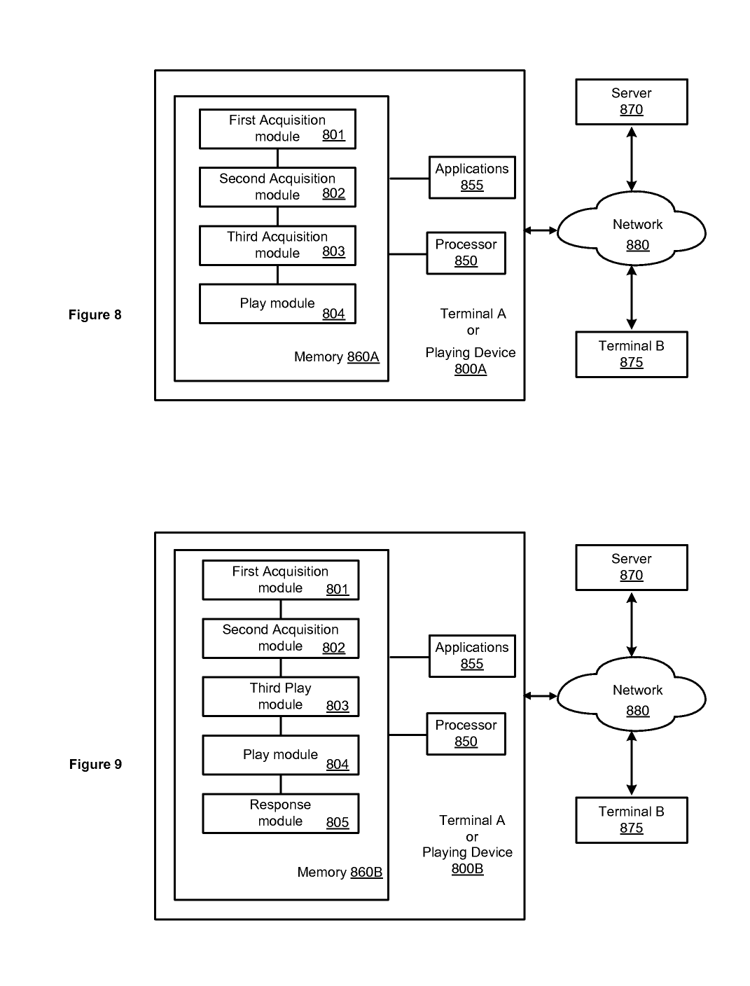

Step 204: acquiring an entire portion of the corresponding media data according to the media link. Specifically, the acquisition of the entire portion of the corresponding media data according to the media link may include but not limited to: requesting from a server (e.g., web server (870) in FIG. 8) through an acquisition request for an entire portion of media data corresponding to the media link.

Step 205: directly playing the acquired media data on the interactive interface of the social application without being redirected to play the acquired media data through a third party webpage or a web application. The entire portion of media data corresponding to the media link may be played on the interactive interface of social application (30). In addition, any media data play modes may be adopted. The media data may be played through steps 201 to 205.

Step 206: acquiring a second instruction which operates on a second identification displayed on the interactive interface of the social application, wherein both the second and the first identifications correspond to a same media link.

Prior to the acquiring of the second instruction which operates on the second identification displayed on the interactive interface of the social application, the method further include: displaying on the interactive interface of the social application, the second identifier corresponding to the media link, and detecting if a triggering action to the second identification has taken place, and upon a successful detection of the triggering action, setting the triggering action being the second instruction to operate on the second identification displayed on the interactive interface of the social application.

Moreover, since the second identification and the first identification both correspond to the same media link, the second identification may include performing functions such as: stopping, skipping forwarding and skipping back the play button.

It should be noted that the second identification and the first identification may be displayed at the same position. When the first identification is clicked, the first identification may become the second identification. On the other hand, the second identification and the first identification can both be displayed at different positions. When the first identification is clicked by the users via a mouse pointer or a touch screen operation, the operation of clicking the first identification is detected; when the second identification will be clicked by the users in the same way, the operation of clicking the second identification will be detected.

To facilitate the understanding, FIG. 4(1)-4(2) are exemplary schematic diagrams of an interactive interface for a social application (40), according to another embodiment of the disclosure. As seen, both the second identification (which may be a stop button (41B)) and the first identification (which may be a playback button (41A)) may be co-located in the same position on interactive interface of social application (40).

Step 207: Execute the second instruction or operate on the second identification according to the second instructions. Since the second instruction for operating the second identification on the interactive interface of social application is acquired, the second instruction may be directly executed in this step. For the execution mode of the second instruction, any of the modes may be adopted. The second instruction may be executed according to specific operation procedures of the second instruction. For example, if the second identification is a stop button (41B), the second instruction may stop the media data from playing.

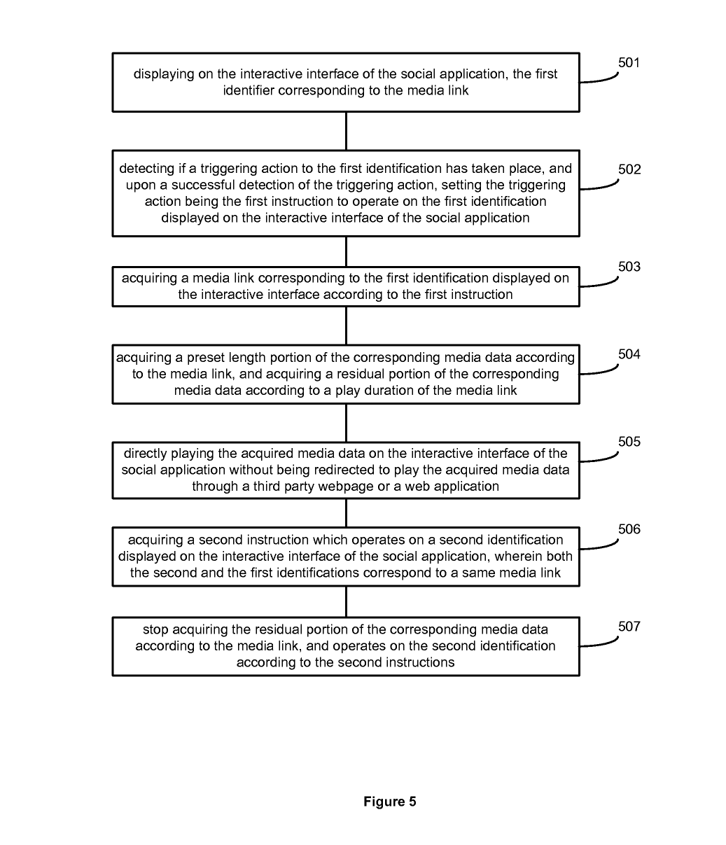

FIG. 5 is an exemplary flowchart illustrating a method of playing media data in a terminal, according to a third embodiment of the disclosure. This embodiment may include the following steps:

Step 501: displaying on the interactive interface of the social application, the first identifier corresponding to the media link. The specific implementation mode in this step is the same as step 201 in FIG. 2, which will not be repeated here.

Step 502: detecting if a triggering action to the first identification has taken place, and upon a successful detection of the triggering action, setting the triggering action being the first instruction to operate on the first identification displayed on the interactive interface of the social application. The specific implementation mode in this step is the same as step 202 in FIG. 2, which will not be repeated here.

Step 503: acquiring a media link corresponding to the first identification displayed on the interactive interface according to the first instruction. The specific implementation mode in this step is the same as step 203 in FIG. 2, which will not be repeated here.

Step 504: acquiring a preset length portion of the corresponding media data according to the media link, and acquiring a residual portion of the corresponding media data according to a play duration of the media link.

Specifically, the acquiring of the preset length portion of the corresponding data according to the media link includes but not limited to: limiting the preset length according to the media link. Firstly dividing all the media data into different segments according to the preset length and time sequence. Afterwards, acquiring the media data with a preset length of the first portion, and then acquiring the residual media data in order. It should be noted that when the residual media data is acquired, in order to guarantee the playing effect, it may be necessary to acquire the media data of the second portion in advance before the media data of the first portion has completed playing, in order for smooth media data playing.

To facilitate an understanding, suppose a length of the entire portion of media data may be 10 minutes and the preset length may be 2 minutes. The media data may be divided into five portions according to the preset length and the time sequence. The portions may include: media data from 0-2 minutes as the first portion, media data from 2-4 minutes as the second portion, media data from 4-6 minutes as the third portion, media data from 6-8 minutes as the fourth portion and media data from 8-10 minutes as the fifth portion. The media data from 0-2 minutes may be firstly acquired. When the media data is played for one minute, the media data from the second portion of 2-4 minutes may be acquired, and so on until the residual media data portions corresponding to the media link on interactive interface of social application may be completely acquired.

Step 505: directly playing the acquired media data on the interactive interface of the social application without being redirected to play the acquired media data through a third party webpage or a web application. Since the media data with preset length corresponding to the media link is acquired according to the media link in step 304, the acquired media data with preset length may be played on the interactive interface of the social application in this step. It should be noted that the residual portion of the media data corresponding to the media link on interactive interface of social application may be acquired according to a play duration with a preset length.

Step 506: acquiring a second instruction which operates on a second identification displayed on the interactive interface of the social application, wherein both the second and the first identifications correspond to a same media link. The specific implementation mode in this step is the same as step 206 in FIG. 2, which will not be repeated here.

Step 507: stop acquiring the residual portion of the corresponding media data according to the media link, and operates on the second identification according to the second instructions. The specific implementation mode in this step is the same as step 207 in FIG. 2, which will not be repeated here.

In step 504, if the media data corresponding to the media link on the interactive interface of social application is not completely acquired according to the second order (i.e. there is residual media data, stop acquiring the residual media data), the media data with a preset length corresponding to the media link may be acquired according to the media link, and the residual media data corresponding to the media link may be acquired according to the play duration. Therefore, the network resource occupied due to acquisition of media data which is not played may be saved and reduced.

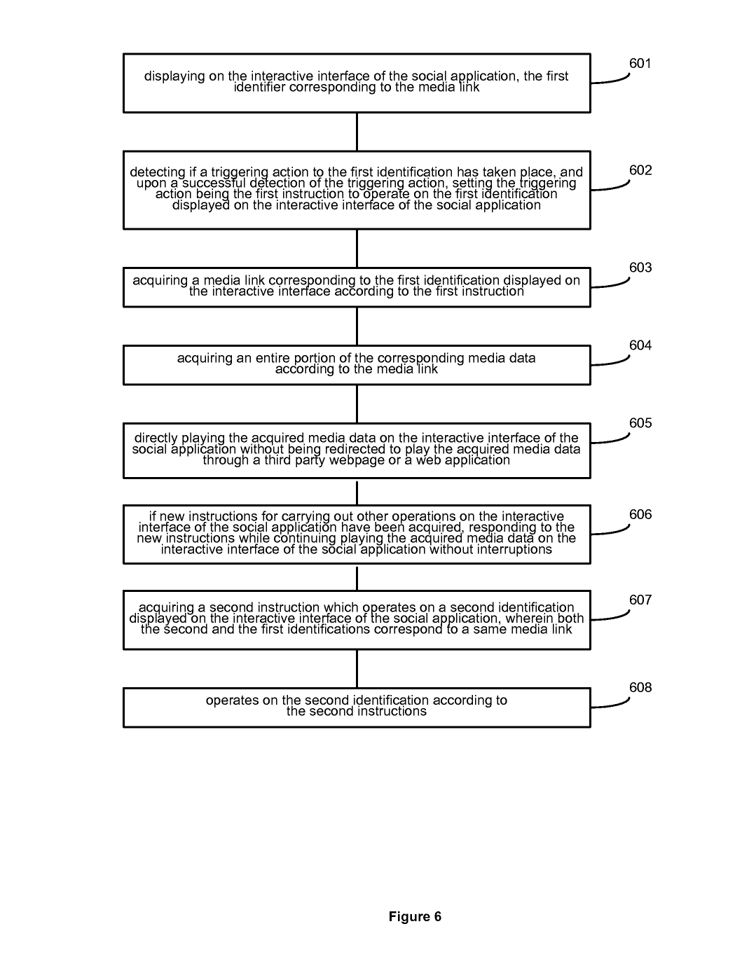

FIG. 6 is an exemplary flowchart illustrating a method of playing media data in a terminal, according to a fourth embodiment of the disclosure. This embodiment may implement many steps (i.e., steps 601-605, and 607-608) similar to the steps (i.e., steps 201-207) of FIG. 2, which will not be repeated, except with the additional step of 606.

Step 606: if new instructions for carrying out other operations on the interactive interface of the social application have been acquired, responding to the new instructions while continuing playing the acquired media data on the interactive interface of the social application without interruptions.

In detail, new instructions may mean any instructions except the instructions to operate on the first and second identifications on the interactive interface of social application. New instructions may include the operational instruction of minimizing the interactive interface of social application and etc. This embodiment may not make specific definitions for other operational orders. It can ensure the continuity of playing media data and bring better playing experience to users to play acquired media data and respond to other operational orders simultaneously.

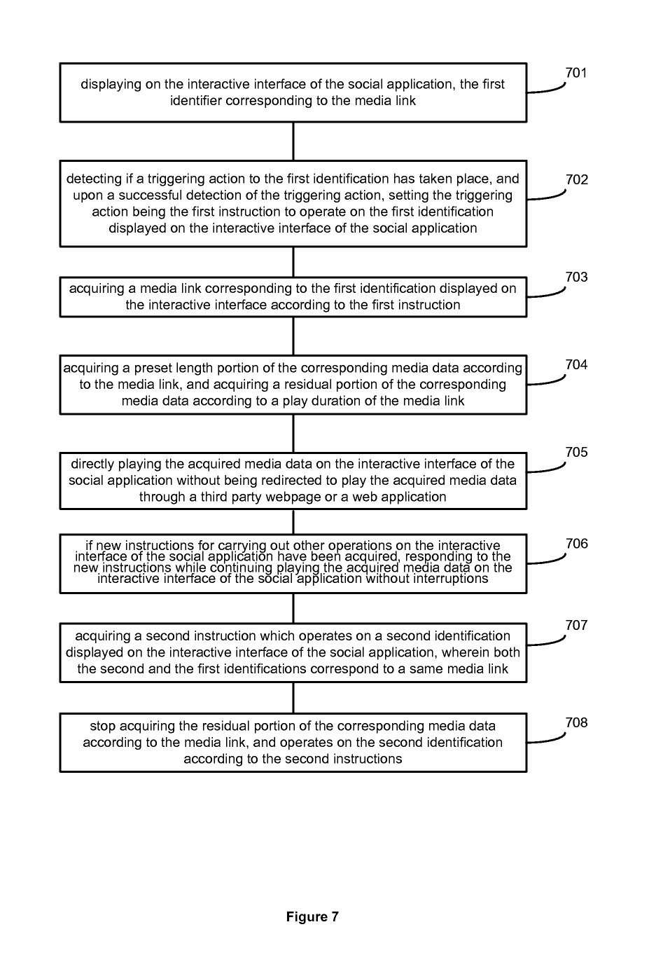

FIG. 7 is an exemplary flowchart illustrating a method of playing media data in a terminal, according to a fifth embodiment of the disclosure. This embodiment may implement many steps (i.e., steps 701-705, and 707-708) similar to the steps (i.e., steps 501-507) of FIG. 5, which will not be repeated, except with the additional step of 706.

Step 706: if new instructions for carrying out other operations on the interactive interface of the social application have been acquired, responding to the new instructions while continuing playing the acquired media data on the interactive interface of the social application without interruptions. This step is similar to the content of Step 506 in FIG. 5, or step 206 in FIG. 2, which will not be repeated.

FIG. 8 is an exemplary structural diagram of a playing device (800A) of a first media data, according to a sixth embodiment of the disclosure. The device (800A) may communicate to another terminal (875) and a web server (870) through a network (880). More specifically, the device (800A) may include at least a processor (850) operating in conjunction with at least a memory (860A) which stores instruction codes operable as plurality of modules, wherein the plurality of modules may include:

A first acquisition module (801), which acquires a first instruction which operates on a first identification displayed on an interactive interface of a social application (855).

A second acquisition module (802), which acquires a media link corresponding to the first identification displayed on the interactive interface according to the first instruction.

A third acquisition module (803), which acquires corresponding media data according to the media link.

A play module (804), which directly plays the acquired media data on the interactive interface of the social application (855) without being redirected to play the acquired media data through a third party webpage or a web application.

As a preferred embodiment, the first acquisition module (801) may also acquire other operational instructions on the interactive interface of social application (855).

FIG. 9 is an exemplary structural diagram of a playing device (800B) of a second media data, according to a sixth embodiment of the disclosure. The device in FIG. 9 include the following modules:

A responsive module (805), configured to after the acquired media data being played on the interactive interface of the social application (855), simultaneously responds to and carries out the other operations in response to the new instructions, while continuing to play the acquired media data on the interactive interface of the social application without interruptions.

A play module (804), which directly plays the acquired media data on the interactive interface of the social application without being redirected to play the acquired media data through a third party webpage or a web application.

As a preferred embodiment, the third acquisition module (803) which acquires corresponding media data according to the media link with preset length corresponding to the media link, and according to playing duration acquired for the remaining or residual portion of media data corresponding to the media link.

As a preferred embodiment, the acquisition module (801) may acquire a second instruction which operates on a second identification displayed on the interactive interface of the social application, wherein both the second and the first identifications correspond to a same media link; and stops acquiring the residual portion of the corresponding media data according to the media link.

The third acquisition module (803) may be configured to stop acquiring the remaining media data corresponding to media link according to the second order.

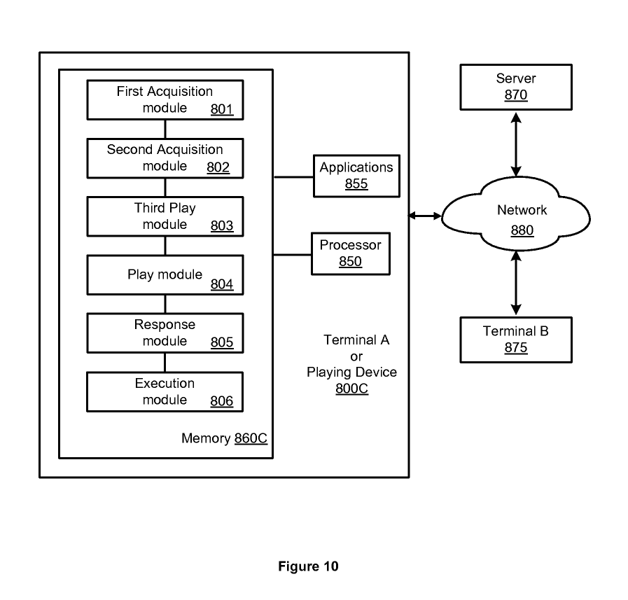

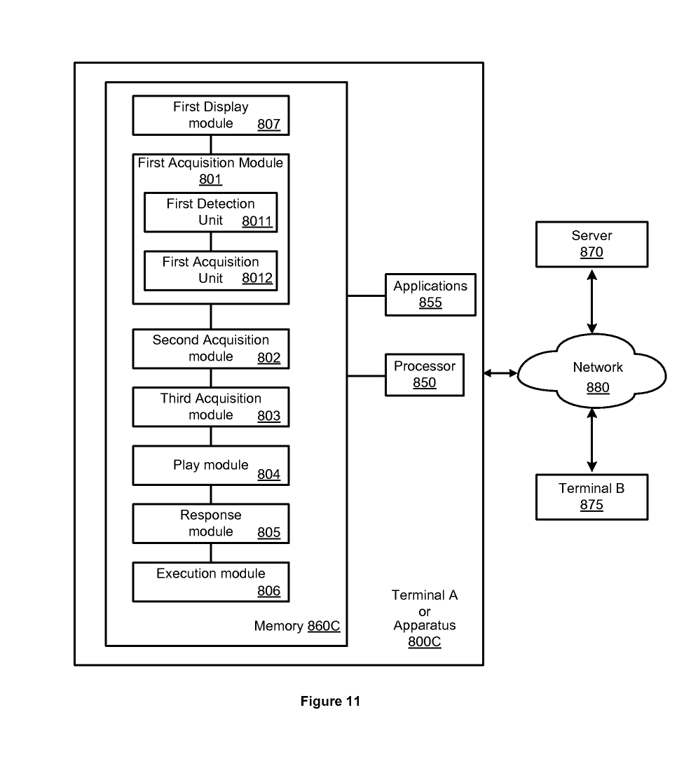

FIG. 10 is an exemplary structural diagram of a playing device (800C) of a third media data, according to a sixth embodiment of the disclosure. The device (800C) in FIG. 10 is similar to the device (800B) in FIG. 9, except with the addition of the following module:

An executive Module (806) which operates on the second identification according to the second instructions.

FIG. 11 is an exemplary structural diagram of a playing device (800D) of a fourth media data, according to a sixth embodiment of the disclosure. The device (800D) in FIG. 11 is similar to the device (800C) in FIG. 10, except with the addition of the following module:

A first display module (807) which displays on the interactive interface of the social application, the first identifier corresponding to the media link.

Furthermore, the first acquisition module (801) may include: a first detection unit (8011), which detects if a triggering action to the first identification has taken place, and upon a successful detection of the triggering action, setting the triggering action being the first instruction to operate on the first identification displayed on the interactive interface of the social application. A first Acquired Unit (8012) may treat the operation of clicking the first identification as the acquired the first instruction of operating the first identification on the interactive interface of social application when the operation of clicking the first identification is detected.

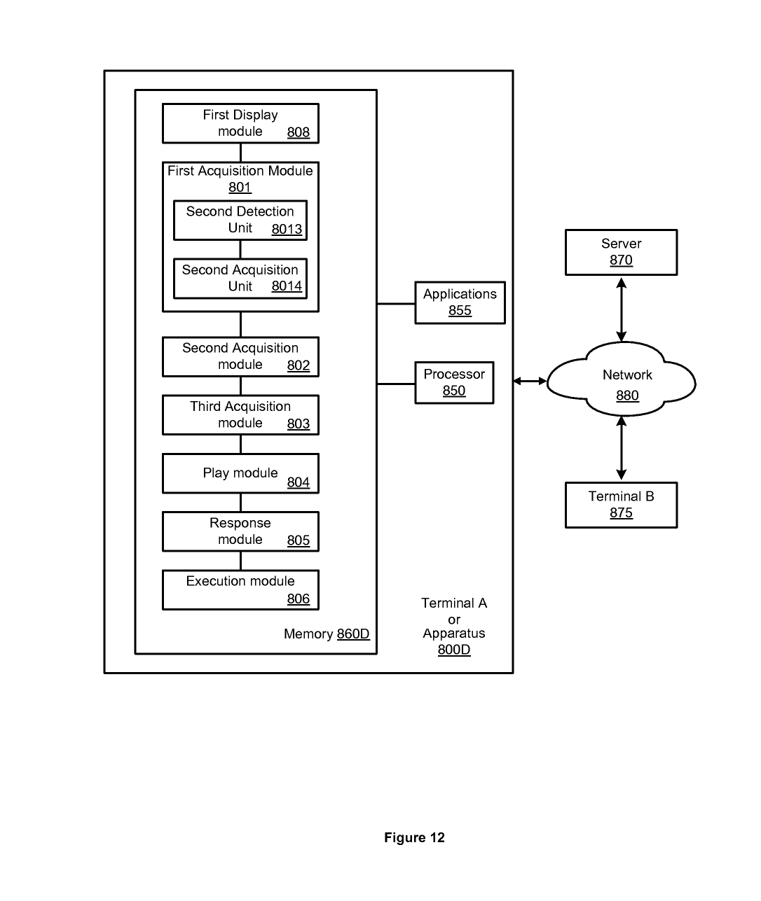

FIG. 12 is an exemplary structural diagram of a playing device (800E) of a fifth media data, according to a sixth embodiment of the disclosure. The device (800E) in FIG. 12 is similar to the device (800D) in FIG. 11, except with the addition of the following details in the first acquisition module (801), which further includes:

A second Display Module (808), which displays on the interactive interface of the social application, the second designated operation corresponding to the media link.

Furthermore, the first Acquisition module (801) further includes:

A second Detection Unit (8013) which detects if a triggering action to the second identification has taken place, and upon a successful detection of the triggering action, setting the triggering action being the second instruction to operate on the second identification displayed on the interactive interface of the social application

A second Acquisition Unit (8014) is configured to treat the operation of clicking the second identification as the acquired the second order of operating the second identification on the interactive interface of social application when the operation of clicking the second identification is detected.

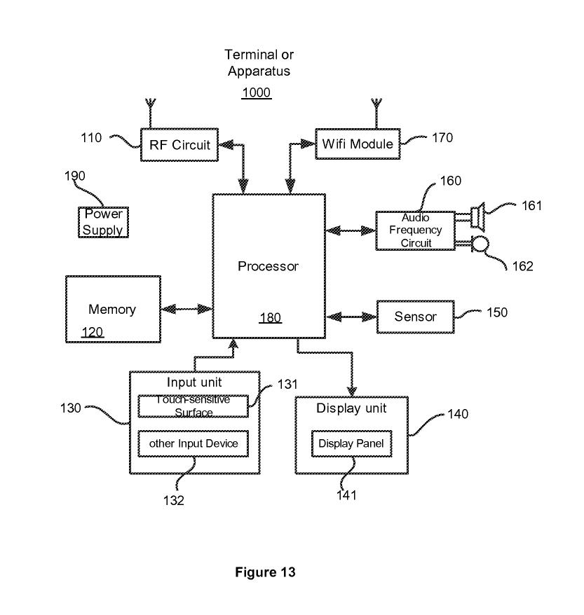

FIG. 13 is an exemplary structural diagram of a playing terminal (1200) of media data, according to a seventh embodiment of the disclosure. The terminal 1200 may include at least: a RF (Radio Frequency) Circuit (110), a Memory (120) which may include one or more non-transitory computer readable storage medium, an Input unit (130), a Display unit (140), a Sensor (150), an Audio Frequency Circuit (160), a WiFi (wireless fidelity) Module (170), a Processor (180) which may include one or more processing cores and a Power Supply (190) etc. A person skilled in the art recognizes that the terminal (1200) is not limited to its structure shown in FIG. 13, it may include more or less components than the components depicted in the Figure, or their equivalence or in any combinations

The RF Circuit (110) may receive and transmit RF signals during a call or sending and receiving information. More specifically, the RF Circuit (110) may receive downlink information from a base station and submit information to one or more Processor (180) for processing. Additionally, the RF Circuit (110) may send data related to the uplink to the base station. Generally, the RF Circuit (110) may include an antenna, at least one amplifier, a tuner, one or more oscillators, User Identity Module (SIM) card, transceiver, coupler, LNA (Low Noise Amplifier) and duplexer, etc. In addition, the RF Circuit (110) may also communicate with other equipment (e.g., terminal B (875) or server (870)) via wireless communications and a network (880). The wireless communication may use any communication standard or protocol, including but not limited to GSM (Global System of Mobile communication), GPRS (General Packet Radio Service), CDMA (Code Division Multiple Access), WCDMA (Wideband Code Division Multiple Access), LTE (Long Term Evolution), e-mail, SMS (Short Messaging Service), etc.

The Memory (120) stores software programs and at least the various disclosed modules, The Processor (180) may run software programs stored in the modules in the memory (120), perform various functions from the applications and process data. The memory (120) may include programs storage area and data storage area, wherein the programs storage area may store the operating system and at least one application with media functions (e.g. sound playback function and image playback function, etc.), etc. The data storage area for storing the generated data (e.g. audio data and phone book, etc.) may depend on the use of the Terminal (1200). In addition, the memory (120) may include high-speed random access memories (RAM), non-volatile memory (ROM), e.g. at least one disks storage device, flash memory devices, or other volatile solid state memory devices. Accordingly, memory (120) may also include a memory controller for providing access to memory (120) by the Processor (180) and the Input unit (130).

The Input unit (130) may receive entered numbers or characters information, and generate keyboard, mouse, joystick and optical or trackball signal input related to user settings and functions control. More specifically, the Input unit (130) may include a Touch-sensitive Surface (131) and other Input Device (132). The Touch-sensitive Surface (131) may also be referred to as touch display screen or touch pad, for collecting the touch operations on or near the screen or pad (e.g. the operations on or near the Touch-sensitive Surface (131) by suitable objects or accessories such as user fingers, stylus etc.), and driving corresponding connecting devices based on the preset programs. Optionally, the Touch-sensitive Surface (131) may include two parts, a touch detection device and a touch controller. Wherein the touch detection device for detecting the user's locations and the signal brought by touch operations, and transmitting the signal to the touch controller. The touch controller may receive touch information from the touch detection device and transform the signals into contact coordinates which will be sent to the Processor (180), and receive and execute the commands from the Processor (180).

In addition, resistance-type, capacitance-type, infrared ray and surface acoustic wave may be applied to form the Touch-sensitive Surface (131). The Input unit (131) may also include other Input Device (132) other than the Touch-sensitive Surface (131). Other Input Device (132) may include but not limited to one or more of physical keyboards, function keys (e.g. volume control buttons, switch keys, etc.), trackballs, mouse, joysticks, etc.

The Display unit (140) for displaying the information entered by the user. The information supplied to the user or a variety of graphical user interfaces (GUI) of the Terminal (1200); graphics, texts, icons, videos and any combination of them may constitute as graphical user interfaces. The Display unit 140 may include a Display Panel (141) which may be configured optionally with LCD (Liquid Crystal Display), OLED (Organic Light-Emitting Diode) etc.

Furthermore, the Display Panel (141) may cover Touch-sensitive Surface (131), when the Touch-sensitive Surface (131) detects touch operations on or near itself, it may send signals to the Processor (180) to determine the type of the touch event, then the Processor (180) may provide corresponding visual outputs on the Display Panel (141), depending on the type of the touch event.

The Terminal (1200) may also include a Sensor (150). For example, the sensor (150) may include at least optical sensors, motion sensors and other sensors. Specifically, the optical sensor may include an ambient light sensor and a proximity sensor, wherein, the ambient light sensor can adjust the brightness of the Display Panel (141) according to the ambient light and darkness, a proximity sensor can turn off Display Panel (141) and/or backlight when the Terminal (1000) is moved to the ear. A Gravity acceleration sensor is a motion sensor, which detects a magnitude of acceleration in all directions (generally triaxial), and detect the magnitude and direction of gravity when it is stationary. The sensor (150) may include mobile phone posture applications (e.g. switch the screen anyway, related games and magnetometer posture calibration) and vibration recognition related functions (e.g. pedometers and percussions), etc.; as to the gyroscope, barometer, hygrometer, thermometer, infrared sensors and other sensors which may also supplied on the Terminal 1200 are need not be repeated here.

The voice frequency or Audio Circuit (160) may include a Speaker (161) and a microphone (162) may provide an audio interface between the user and the Terminal (1200). The Audio Circuit (160) may convert the received audio data into an electrical signal to be transmitted to the Speaker (161), Electrical signals may be converted into a sound signal output; On the other hand, the collected sound signal may be converted into electrical signals by Speaker (162), The Audio Circuit (160) may receive the electrical signals and converts them into audio data which may be exported to the Processor (180) for processing and transmitted to another terminal via the RF Circuit (110) or exported to memory (120) for further processing. The Audio Circuit (160) may also include earplug jack to provide communication between the peripheral headset and the Terminal (1200).

WiFi is a technology of short range wireless transmission, the Terminal (1200) can help users to send and receive email, browse the web and access streaming media etc. via the WiFi Module (170), provide users with wireless broadband Internet access.

The Processor (180) may be a control center of the Terminal (1000), for using a variety of interfaces and lines to connect various parts throughout a mobile phone, and executing various functions of the Terminal (1200) and processing data by running or executing software programs and/or modules stored in memory (120) and calling the data stored in memory (120), to achieve the overall control of the mobile phone. Optionally, the Processor (180) may include one or more processing cores; preferably, the Processor (180) may be integrated with an application processor and a modem processor, wherein the application processor is mainly used to process operating system, user interface and applications etc. A modem processor may be used to process wireless communications. It can be understood that the modem processor may not be integrated into Processor 180.

The Terminal (1200) may also include a Power Supply (190) (e.g. a battery) which powers the various components, preferably, the power supply can achieve logic connection with the Processor (180) via the power supply management system, and thus achieving functions such as charging, discharging and power consumption management via the power supply management system. Power Supply (190) may also include one or more power sources such as a DC supply or an AC power supply, recharging system, power supply failure detection circuit, power supply converter or inverter and power supply status indicator etc.

Although not shown in FIG. 10, the Terminal (1200) may also include a camera, a Bluetooth module etc., which need not be described here. Specifically in this embodiment, the display unit of the terminal is a touch display screen, the terminal also includes memories and one or more programs, wherein the one or more programs are stored in the memories and will be executed by one or more processors after configured, in which the commands for following operations are included in the various embodiments of the methods and devices.

In conclusion, the terminal provided by this Embodiment includes the following steps: the first order for operating the first identification on the interactive interface of the social application is acquired firstly, then the media link corresponding to the first identification on the interactive interface is acquired according to the first order, the corresponding media data is acquired according to the media link, and the acquired media data is played on the interactive interface of the social application, so the media data can be played without skipping from the interactive interface of the social application to that of another application, the resource consumption of the system is reduced, the user wait time is shortened, and the playing efficiency of the media data is increased; moreover, the media data can be played in absence of the skip, so the complexity of playing the media data is reduced, and use convenience is brought to users.

### Additional Embodiment

This Embodiment provides a non-transitory computer readable medium which stores instruction codes operable to carry out steps on a terminal, the steps include: acquiring a first instruction which operates on a first identification displayed on an interactive interface of a social application; acquiring a media link corresponding to the first identification displayed on the interactive interface according to the first instruction; acquiring corresponding media data according to the media link; and directly playing the acquired media data on the interactive interface of the social application without being redirected to play the acquired media data through a third party webpage or a web application.

Assume that the above description is the first possible way of implementation, so in the second possible way of implementation based on the first one, the memory of the terminal also includes instructions for the following operations: after the acquired media data being played on the interactive interface of the social application, if new instructions for carrying out other operations on the interactive interface of the social application have been acquired, responding to the new instructions while continuing playing the acquired media data on the interactive interface of the social application without interruptions.

In a third possible way of implementation based on the first one, the memory of the terminal also includes orders for following operations: acquiring an entire portion of the corresponding media data according to the media link.

In a fourth possible way of implementation based on the first one, the memory of the terminal also includes orders for following operations: wherein the acquiring of the corresponding media data according to the media link, including acquiring a preset length portion of the corresponding media data according to the media link, and acquiring a residual portion of the corresponding media data according to a play duration of the media link.

In a fifth possible way of implementation based on the fourth one, the memory of the terminal also includes orders for following operations: after the acquiring of the preset length portion of the corresponding media data according to the media link, the method further including: acquiring a second instruction which operates on a second identification displayed on the interactive interface of the social application, wherein both the second and the first identifications correspond to a same media link; and stop acquiring the residual portion of the corresponding media data according to the media link, and operates on the second identification according to the second instructions.

In the sixth possible way of implementation based on the first to the fifth ones, the memory of the terminal also includes orders for following operations: prior to the acquiring of the first instruction which operates on the first identification displayed on the interactive interface of a social application, the method further including: displaying on the interactive interface of the social application, the first identifier corresponding to the media link; wherein the acquiring of the first instruction, including: detecting if a triggering action to the first identification has taken place, and upon a successful detection of the triggering action, setting the triggering action being the first instruction to operate on the first identification displayed on the interactive interface of the social application.

While the seventh possible way of implementation is based on the fifth one, the memory of the terminal also includes orders for following operations: prior to the acquiring of the second instruction which operates on the second identification displayed on the interactive interface of the social application, the method further including: displaying on the interactive interface of the social application, the second identifier corresponding to the media link; wherein the acquiring of the second instruction, including: detecting if a triggering action to the second identification has taken place, and upon a successful detection of the triggering action, setting the triggering action being the second instruction to operate on the second identification displayed on the interactive interface of the social application.

Moreover, in the above methods and embodiments disclosed, wherein the directly playing of the acquired media data on the interactive interface of the social application without being redirected to play the acquired media data through a third party webpage or web application, including: directly playing the media data stored on a web server according to a Uniform Resource Locator (URL) address which corresponds to the media link, wherein the URL address has been embedded in the first identification displayed on the interactive interface of the social application.

In conclusion, the computer readable storage medium provided by this Embodiment of the present disclosure enables the acquired media data to be played on the interactive interface of the social application without skipping from the interactive interface of the social application to that of another application, the resource consumption of the system is reduced, the user wait time is shortened, and the playing efficiency of the media data is increased; moreover, the media data can be played in absence of the skip, so the complexity of playing the media data is reduced, and use convenience is brought to users.

In another embodiment, the recited functions in the method claims of the disclosure may be implemented using a graphical user interface on a touch screen display of a terminal.

### Embodiment IX

This Embodiment of present disclosure provides a graphic user interface. It can be configured to the terminal which includes touch screen monitor, memory, one or more programs and processors. This graphic user interface includes performing the functions of: acquiring a first instruction which operates on a first identification displayed on an interactive interface of a social application; acquiring a media link corresponding to the first identification displayed on the interactive interface according to the first instruction; acquiring corresponding media data according to the media link; and directly playing the acquired media data on the interactive interface of the social application without being redirected to play the acquired media data through a third party webpage or a web application.

In conclusion, the graphic user interface provided by this Embodiment enables the acquired media data to be played on the interactive interface of the social application without skipping from the interactive interface of the social application to that of another application, the resource consumption of the system is reduced, the user wait time is shortened, and the playing efficiency of the media data is increased; moreover, the media data can be played in absence of the skip, so the complexity of playing the media data is reduced, and use convenience is brought to users.

It should be understood by those with ordinary skill in the art that all or some of the steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive. ROM or flash memory. The computer-executable commands are used to enable a computer, server, a smart phone, a tablet or any similar computing device to render using speech to control to an application startup and its operations on a terminal.

The foregoing represents only some preferred embodiments of the present disclosure and their disclosure cannot be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent has changed and modifications of the foregoing embodiments are to be viewed as being within the scope of the technical solution of the present disclosure.

What is claimed is:

1. A method for playing media data on a terminal, comprising:
acquiring a first instruction which operates on a first identification displayed on an interactive interface of a social application;
acquiring a media link corresponding to the first identification displayed on the interactive interface according to the first instruction;
acquiring corresponding media data according to the media link; and
directly playing the acquired media data on the interactive interface of the social application without being redirected to play the acquired media data through a third party webpage or a web application.

2. The method according to claim 1, the method further comprising:
after the acquired media data being played on the interactive interface of the social application, if new instructions for carrying out other operations on the interactive interface of the social application have been acquired, responding to the new instructions while continuing playing the acquired media data on the interactive interface of the social application without interruptions.

3. The method according to claim 1, wherein the acquiring of the corresponding media data according to the media link, comprising:
acquiring an entire portion of the corresponding media data according to the media link.

4. The method according to claim 1, wherein the acquiring of the corresponding media data according to the media link, comprising:
acquiring a preset length portion of the corresponding media data according to the media link, and acquiring a residual portion of the corresponding media data according to a play duration of the media link.

5. The method according to claim 4, wherein after the acquiring of the preset length portion of the corresponding media data according to the media link, the method further comprising:
acquiring a second instruction which operates on a second identification displayed on the interactive interface of the social application, wherein both the second and the first identifications correspond to a same media link; and
stop acquiring the residual portion of the corresponding media data according to the media link, and operates on the second identification according to the second instructions.

6. The method according to claim 1, wherein prior to the acquiring of the first instruction which operates on the first identification displayed on the interactive interface of a social application, the method further comprising:
displaying on the interactive interface of the social application, the first identifier corresponding to the media link;
wherein the acquiring of the first instruction, comprising:
detecting if a triggering action to the first identification has taken place, and upon a successful detection of the triggering action, setting the triggering action being the first instruction to operate on the first identification displayed on the interactive interface of the social application.

7. The method according to claim 5, wherein prior to the acquiring of the second instruction which operates on the second identification displayed on the interactive interface of the social application, the method further comprising:
displaying on the interactive interface of the social application, the second identifier corresponding to the media link;
wherein the acquiring of the second instruction, comprising:
detecting if a triggering action to the second identification has taken place, and upon a successful detection of the triggering action, setting the triggering action being the second instruction to operate on the second identification displayed on the interactive interface of the social application.

8. The method according to claim 1, wherein the directly playing the acquired media data on the interactive interface of the social application without being redirected to play the acquired media data through a third party webpage or web application, comprising:
directly playing the media data stored on a web server according to a Uniform Resource Locator (URL) address which corresponds to the media link, wherein the URL address has been embedded in the first identification displayed on the interactive interface of the social application.

9. A device for playing media data, comprises at least a processor operating in conjunction with at least a memory which stores instruction codes operable as plurality of modules, wherein the plurality of modules comprise:
a first acquisition module, which acquires a first instruction which operates on a first identification displayed on an interactive interface of a social application;
a second acquisition module, which acquires a media link corresponding to the first identification displayed on the interactive interface according to the first instruction;
a third acquisition module, which acquires corresponding media data according to the media link; and
a play module, which directly plays the acquired media data on the interactive interface of the social application without being redirected to play the acquired media data through a third party webpage or a web application.

10. The device according to claim 9, wherein the first acquisition module acquires new instructions for carrying out other operation on the interactive interface of the social application;
the device further comprises:
a response module, configured to after the acquired media data being played on the interactive interface of the social application, simultaneously responds to and carries out the other operations in response to the new instructions, while continuing to play the acquired media data on the interactive interface of the social application without interruptions.

11. The device according to claim 9, wherein the third acquisition module acquires an entire portion of the corresponding media data according to the media link.

12. The device according to claim 9, wherein the third acquisition module acquires a preset length portion of the corresponding media data according to the media link, and acquiring a residual portion of the corresponding media data according to a play duration of the media link.

13. The device according to claim 12, wherein the first acquisition module acquires a second instruction which operates on a second identification displayed on the interactive interface of the social application, wherein both the second and the first identifications correspond to a same media link; and stops acquiring the residual portion of the corresponding media data according to the media link;
wherein the device further comprises: an execution module which operates on the second identification according to the second instructions.

14. The device according to claim 9, comprises:
a first display module, which displays on the interactive interface of the social application, the first identifier corresponding to the media link;
wherein the first acquisition module comprises:
a first detection unit, which detects if a triggering action to the first identification has taken place, and upon a successful detection of the triggering action, setting the triggering action being the first instruction to operate on the first identification displayed on the interactive interface of the social application.

15. The device according to claim 13, wherein the device also comprises:
a second display module, which displays on the interactive interface of the social application, the second designated operation corresponding to the media link;
wherein the first acquisition module comprises:
a second detection unit, which detects if a triggering action to the second identification has taken place, and upon a successful detection of the triggering action, setting the triggering action being the second instruction to operate on the second identification displayed on the interactive interface of the social application.

16. The device according to claim 9, wherein the directly playing of the acquired media data on the interactive interface of the social application without being redirected to a third party webpage or web application to play the acquired media data, comprising:
directly playing the media data stored on a web server according to a Uniform Resource Locator (URL) address which corresponds to the media link, wherein the URL address has been embedded in the first identification displayed on the interactive interface of the social application.

17. A terminal for playing media data, comprises at least a processor operating in conjunction with at least a memory and a non-transitory computer readable medium which stores instruction codes operable to carry out steps, comprising:
acquiring a first instruction which operates on a first identification displayed on an interactive interface of a social application;
acquiring a media link corresponding to the first identification displayed on the interactive interface according to the first instruction;
acquiring corresponding media data according to the media link; and
directly playing the acquired media data on the interactive interface of the social application without being redirected to play the acquired media data through a third party webpage or a web application.

18. The terminal according to claim 17, wherein the instruction codes are operable to further carry out steps, comprising:
if new instructions for carrying out other operations on the interactive interface of the social application have been acquired, responding to the new instructions while continuing playing the acquired media data on the interactive interface of the social application without interruptions.

19. The terminal according to claim 17, wherein the instruction codes operable to further carry out steps, comprising:
acquiring an entire portion of the corresponding media data according to the media link.

20. The terminal according to claim 17, wherein the instruction codes operable to further carry out steps, comprising:
acquiring a preset length portion of the corresponding media data according to the media link, and acquiring a residual portion of the corresponding media data according to a play duration of the media link.

21. The terminal according to claim 20, wherein the instruction codes operable to further carry out steps, comprising:
wherein after the acquiring of the preset length portion of the corresponding media data according to the media link, the steps further comprising:
acquiring a second instruction which operates on a second identification displayed on the interactive interface of the social application, wherein both the second and the first identifications correspond to a same media link; and
stop acquiring the residual portion of the corresponding media data according to the media link, and operates on the second identification according to the second instructions.

22. The terminal according to claim 17, wherein the instruction codes operable to further carry out steps, comprising:
wherein prior to the acquiring of the first instruction which operates on the first identification displayed on the interactive interface of a social application, the steps further comprising:
displaying on the interactive interface of the social application, the first identifier corresponding to the media link;
wherein the acquiring of the first instruction, comprising:
detecting if a triggering action to the first identification has taken place, and upon a successful detection of the triggering action, setting the triggering action being the first instruction to operate on the first identification displayed on the interactive interface of the social application.

23. The terminal according to claim 21, wherein the instruction codes operable to further carry out steps, comprising:
wherein prior to the acquiring of the second instruction which operates on the second identification displayed on the interactive interface of the social application, the steps further comprising:
displaying on the interactive interface of the social application, the second identifier corresponding to the media link;
wherein the acquiring of the second instruction, comprising:
detecting if a triggering action to the second identification has taken place, and upon a successful detection of the triggering action, setting the triggering action being the second instruction to operate on the second identification displayed on the interactive interface of the social application.

24. The terminal according to claim 19, wherein the directly playing the acquired media data on the interactive interface of the social application without being redirected to a third party webpage or web application to play the acquired media data, the steps further comprising:
directly playing the media data stored on a web server according to a Uniform Resource Locator (URL) address which corresponds to the media link, wherein the URL address has been embedded in the first identification displayed on the interactive interface of the social application.
